(19) United States
(12) Patent Application Publication
(10) Pub. No.: US 2016/0196311 A1
(43) Pub. Date: Jul. 7, 2016

(54) DATA QUALITY MEASUREMENT METHOD AND SYSTEM BASED ON A QUARTILE GRAPH

(71) Applicant: SHENZHEN AUDAQUE DATA TECHNOLOGY LTD, Middle Nanshan District Shenzhen (CN)

(72) Inventors: Mingxing Wang, Shenzhen (CN); Wenfei Fan, Shenzhen (CN); Xibei Jia, Shenzhen (CN)

(21) Appl. No.: 14/655,270

(22) PCT Filed: Aug. 18, 2014
(86) PCT No.: PCT/CN2014/084612

§ 371 Date: Jun. 24, 2015

(30) Foreign Application Priority Data
Sep. 26, 2013 (CN) 201310443085.6

(51) Int. Cl. G06F 17/30

(52) U.S. Cl. CPC G06F 17/30536; G06F 17/30554

(57) ABSTRACT

The present invention provides a data quality measurement method based on a quartile graph, the method comprising: defining a data grid (Gx) and fitting a plurality of trend lines; scanning a data source and storing, and according to actual trends of the data, selecting a trend line and displaying data; generating data quality rules according to the determined trend line type and parameters; selecting appropriate data quality rules and measuring data quality according to a threshold. By means of defining a data grid (Gx) to store data, using a quartile graph to display data, and generating data quality rules according to the determined trend line type and parameters, and further setting a threshold according to said rules and measuring data quality, the present invention performs, for enormous amounts of data, applications such as display of data, analysis of abnormal data, and data error correction. In addition, another embodiments of the present invention provides a data quality measurement system based on a quartile graph.

### TECHNICAL FIELD

The present disclosure relates to data field, and particularly to a data quality measurement method and system based on a quartile graph.

### BACKGROUND

A Quartile graph, a diagram displaying the distribution of one-dimensional data, can directly show the distribution pattern of data, including five data points: lowest quartile, first quartile, median quartile, third quartile and highest quartile. The lowest quartile and the highest quartile refer to the minimum value and the maximum value respectively, the first quartile means that 25% of all the data is less than the value corresponding to the first quartile, similarly, the median quartile means that 50% of all the data is less than the value corresponding to the median quartile, and the third quartile means that 75% of all the data is less than the value corresponding to the third quartile. The quartile graph is only a tool for displaying, and only for displaying the distribution of one-dimensional data. Hence there lacks a method for displaying and analyzing the distribution of two-dimensional data and for data error correction by taking advantage of basic features of the quartile graph.

### SUMMARY

Consequently, the present disclosure is aimed to solve one of the above-mentioned drawbacks.

Therefore, the present disclosure provides a data quality measurement method and system based on a quartile graph. By means of defining a data grid (Gx) to store data, using a quartile graph to display data, and generating data quality rules according to a determined trend line type and parameters, and further setting a threshold according to said rules and measuring data quality, the present invention performs, for enormous amounts of data, applications such as display of data, analysis of abnormal data, and data error correction.

Therefore, one embodiment of the present disclosure provides a data quality measurement method based on a quartile graph, comprising: defining a data grid (Gx) and fitting a plurality of trend lines; scanning a data source and storing, and according to actual trends of the data, selecting a trend line and displaying data; generating data quality rules according to the determined trend line type and parameters; selecting appropriate data quality rules and measuring data quality according to a threshold.

In one embodiment of the present disclosure, performing selection of the trend line and display of the data on a quartile graph.

In one embodiment of the present disclosure, the data grid (Gx) is defined before scanning the data source, said scanning a data source and storing comprises: scanning the data source, reading every recorded values of X and Y: x and y; according to the display scale of the X axis, calculating the data grid (Gx) corresponding to x and y, and storing the corresponding data into Gx.

Preferably, the calculated data grid (Gx) corresponding to x and y comprises: lowest quartile, first quartile, median quartile, third quartile, and highest quartile.

The data displayed on the quartile graph is the data stored in Gx.

In one embodiment of the present disclosure, said fitting a plurality of trend lines comprises: according to the total record numbers and the sums of all effective data grids Gx, calculating the average values of X and Y; for Gx, calculating the general average value of X and the general average value of Y, and fitting every type of trend line based on the general average values.

Preferably, the plurality of trend lines is displayed in the form of a list on the quartile graph.

Preferably, said selecting a trend line can be performed a manual adjustment.

Preferably, the manual adjustment comprises: directly modifying trend line formula in the quartile graph.

Preferably, the manual adjustment comprises: dragging a mouse in the quartile graph to display the change of the trend line in real time.

In one embodiment of the present disclosure, said generating data quality rules comprises that according to the trend line, calculates the target value, and sets a floating range to the target value.

Preferably, the floating range is an absolute value.

Preferably, the floating range is a percentage.

In one embodiment of the present disclosure, said measuring data quality comprises that according to the selected data quality rules and a threshold, performs a measurement; the threshold is the floating range.

Another embodiment of the present disclosure provides a data quality measurement system based on a quartile graph, the system comprising:

a trend line fitting unit configured for defining a data grid (Gx) and fitting a plurality of trend lines;

a data source reading unit configured for scanning a data source and storing, and according to actual trends of the data, selecting a trend line and displaying data;

a data quality rule generating unit configured for generating data quality rules according to the determined trend line type and parameters;

a data quality measuring unit configured for selecting appropriate data quality rules and measuring data quality according to a threshold;

the system comprising a data display unit configured for performing selection of the trend line and display of the data on a quartile graph.

By means of defining a data grid (Gx) to store data, using a quartile graph to display data, and generating data quality rules according to the determined trend line type and parameters, and further setting a threshold according to said rules and measuring data quality, the present invention performs, for enormous amounts of data, applications such as display of data, analysis of abnormal data, and data error correction.

### BRIEF DESCRIPTION OF THE DRAWINGS

FIG. 1 is a detailed flowchart illustrating a data quality measurement method and system based on a quartile graph provided in one embodiment of the present disclosure.

FIG. 2 is a schematic diagram of the data grid Gx defined in one embodiment of the present disclosure.

### DETAILED DESCRIPTION

The present disclosure will be described in detail by reference to the accompanying drawings and embodiments for more clearly understanding of the objects, technical features and advantages of the present disclosure. It should be understood that specific embodiments described herein are intended for purposes of illustration only and are not intended to limit the scope of the present disclosure.

The present disclosure provides a data quality measurement method and system based on a quartile graph. By means of defining a data grid (Gx) to store data, using a quartile graph to display data, and generating data quality rules according to the determined trend line type and parameters, and further setting a threshold according to said rules and measuring data quality, the present invention performs, for enormous amounts of data, applications such as display of data, analysis of abnormal data, and data error correction.

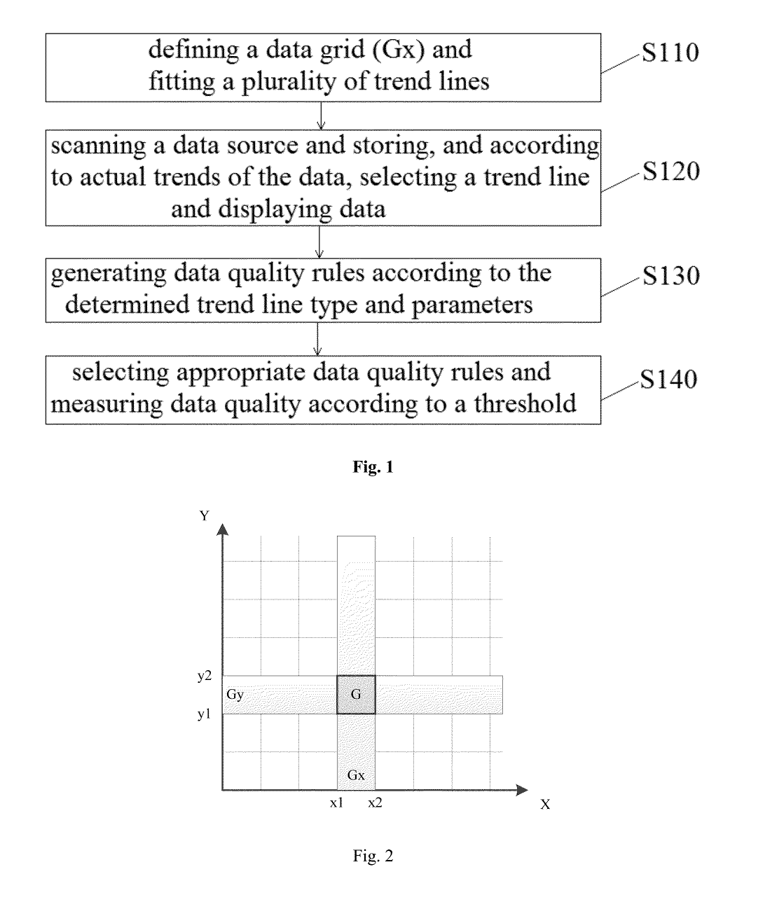

As shown in FIG. 1, it is a detailed flowchart of the data quality measurement method provided in one embodiment of the present disclosure. The specific steps of the method are as follows:

Step S110: defining a data grid Gx, and fitting a plurality of trend lines.

In one embodiment of the present disclosure, to use a quartile graph to display and analyze two-dimensional data, Gx should be defined in advance. Assumed that the distributions of an independent variable X and dependent variable Y are needed to be displayed, the independent variable X is needed to be discretized. For ease of demonstration, the maximum and minimum values of X are needed to be adjusted, and the value range of X is divided equally into a series of Gx. Accordingly, referring to FIG. 2, Gx is defined as follows:

defining Gx{x1, x2} as G{(x,y)|x1<=x<x2}, Gx for short, i.e., all points (x,y) satisfied x1<=x<x2.

There are four display scales of Gx which support interchangeable with each other.

Step S120: scanning a data source and storing, and according to actual trends of the data, selecting a trend line and displaying data.

In one embodiment of the present disclosure, the data grid (Gx) is defined before scanning the data source, said scanning a data source and storing comprises: scanning the data source, reading every recorded values of X and Y: x and y. Before scanning the data source, in the present disclosure, according to the value range of the X axis, the maximum and minimum values are adjusted to make the minimum and maximum values to be the multiple of the nth power (n is an integer) of 10, i.e., Xmin (or Xmax)=m*10̂n. For example, the actual value range of X is [0.1, 983.7], the minimum value of the adjusted X is 0 and the maximum value is 1000, i.e., the value range is changed to [0, 1000]. Then the data source is scanned to get every recorded values of X and Y i.e. x and y, thereby according to the display scale of the X axis, calculating the data grid Gx corresponding to x and y, and storing the data to the Gx. For example, if x=155.3 and the scale of the X axis is “10”, 155.3/10=15.53, then Gx is Gx{150,160}, while the scales is “1”, Gx belongs to Gx{155,156}. The calculated data grid (Gx) corresponding to x and y comprises: lowest quartile, first quartile, median quartile, third quartile, and highest quartile.

Step S120: according to actual trends of the data, selecting a trend line and displaying data.

In one embodiment of the present disclosure, selection of the trend line and display of the data are performed on a quartile graph, and the data displayed in the quartile graph is the data stored in Gx. The present disclosure realizes displaying two-dimensional data by using a quartile graph, and said fitting trend lines is performed according to the average values of all x and y within every display scale level, the selected trend line types comprise:

straight line: y=a+b*x;

logarithmic curve: y=a+b*ln(x+1);

exponential curve: y=k+a*b̂x;

quadratic curve: y=a+b*x+c*x̂2;

Gompertz curve: y=k*â(b̂x);

logistic curve: y=l/(k+a*b̂x);

periodic curve: y=a*x+b*sin(c*x+d).

In one embodiment of the present disclosure, the plurality of trend lines is displayed in the form of a list on the quartile graph, said selecting trend line is performed according to actual situation of the data, for example a trend line is changed to be a logarithmic curve. When the fitted trend line parameters displayed on the quartile graph meet the demand of display, in the present disclosure, the trend line can be manually adjusted with two preferred ways of adjustment: directly modifying the trend line formula on the quartile graph, and dragging a mouse on the quartile graph to display the change of the trend line in real time.

Step 5130: generating data quality rules according to the determined trend line type and parameters.

In one embodiment of the present disclosure, generating data quality rules comprises: providing that the trend line is y=f(x), i.e., for a value x, the target value y can be calculated according to the trend line; setting a floating range for the target value to generate data quality rules; wherein the floating range can be set to be an absolute value or in the form of a percentage. Provided that the trend line is y=f(x), i.e., for a value x, the target value y can be calculated according to the trend line, and a reasonable floating range (a threshold) is given to the target value, thereby configuring data quality rules. There are two ways to define the floating range. One is in the form of an absolute value, for example, supposing an upper limit is 50 and a lower limit is 40, when the target value is 200, the actual value is reasonable within the interval [160, 250]. Another way is in the form of a percentage, for example, supposing both the upper and lower limits are 20% and the target value is 200, the actual value is reasonable within the interval [160, 200]. The defined data rules can be saved to a rule base to be used later if necessary.

Step S140: selecting appropriate data quality rules and measuring data quality according to a threshold.

In one embodiment of the present disclosure, measuring data quality comprises: selecting appropriate data quality rules based on the actual situation of displaying data on the quartile graph, for each input data (x,y), calculating the target value y′ corresponding to x according to the trend lines technique of the rules; configuring the threshold to be a value or a percentage, calculating the reasonable interval of the target value to judge the data quality of the actual value y. Provided that the trend of data rules is y=37.9+20*x/1000, the threshold is 20%, as for an input data (10000, 213), its target value can be calculated, i.e., 37.9+20*10/1000=237.9, the reasonable interval is [237.9*0.8, 237.9*1.2]=[190.32, 285.48], the actual value 213 belongs to the interval, so the data (10000, 213) is a reasonable data. Similarly, the data (32000, 511) is determined as an abnormal data. The present disclosure generates data quality rules according to determined trend lines, and according to the rules, sets a threshold to perform data quality measurement, thus achieving applications such as analysis of abnormal data and data error correction.

Another embodiment of the present disclosure provides a data quality measurement system based on a quartile graph, the system comprising:

a trend line fitting unit configured for defining a data grid (Gx) and fitting a plurality of trend lines; a data source reading unit configured for scanning a data source and storing, and according to actual trends of the data, selecting a trend line and displaying data; a data quality rule generating unit configured for generating data quality rules according to the determined trend line type and parameters; a data quality measuring unit configured for selecting appropriate data quality rules and measuring data quality according to a threshold, wherein comprising a data display unit configured for performing selection of the trend line and display of the data on a quartile graph. By means of defining a data grid (Gx) to store data, using a quartile graph to display data, and generating data quality rules according to the determined trend line type and parameters, and further setting a threshold according to said rules and measuring data quality, the present invention performs, for enormous amounts of data, applications such as display of data, analysis of abnormal data, and data error correction.

What is described above is a further detailed explanation of the present disclosure in combination with specific embodiments; however, it cannot be considered that the specific embodiments of the present invention are only limited to the explanation. For those of ordinary skill in the art, some simple deductions or replacements can also be made under the premise of the concept of the present invention.

1. A data quality measurement method based on a quartile graph, comprising: defining a data grid (Gx) and fitting a plurality of trend lines; scanning a data source and storing, and according to actual trends of the data, selecting a trend line and displaying data; generating data quality rules according to the determined trend line type and parameters; selecting appropriate data quality rules and measuring data quality according to a threshold, wherein, both selection of the trend line and display of the data are performed on a quartile graph, wherein the data grid (Gx) is defined before scanning the data source and wherein said scanning a data source and storing comprises:
scanning the data source, reading every recorded values of X and Y: x and y;
according to the display scale of the X axis, calculating the data grid (Gx) corresponding to x and y, and storing the corresponding data into Gx.

2. (canceled)

3. (canceled)

4. The method according to claim 1, wherein the data displayed on the quartile graph is the data stored in Gx.

5. The method according to claim 1, wherein the calculated data grid (Gx) corresponding to x and y comprises: lowest quartile, first quartile, median quartile, third quartile, and highest quartile.

6. The method according to claim 1, wherein said fitting a plurality of trend lines comprises:
according to the total record numbers and the sums of all effective data grids Gx, calculating the average values of X and Y;
for Gx, calculating the general average value of X and the general average value of Y, and fitting every trend line according to the general average values.

7. The method according to claim 1, wherein the plurality of trend lines is displayed in the form of a list on the quartile graph.

8. The method according to claim 1, wherein said selecting a trend line can be performed a manual adjustment.

9. The method according to claim 8, wherein the manual adjustment comprises: directly modifying trend line formula in the quartile graph.

10. The method according to claim 8, wherein the manual adjustment comprises: dragging a mouse in the quartile graph to display the change of the trend line in real time.

11. The method according to claim 1, wherein said generating data quality rules comprises that according to the trend line, calculates the target value, and sets a floating range to the target value.

12. The method according to claim 11, wherein the floating range is an absolute value.

13. The method according to claim 11, wherein the floating range is a percentage.

14. The method according to claim 11, wherein said measuring data quality, according to the selected data quality rules and a threshold, performs a measurement; the threshold is the floating range.

15. (canceled)
